(19) United States
(12) Patent Application Publication
(10) Pub. No.: US 2009/0295148 A1
(43) Pub. Date: Dec. 3, 2009

(54) CONNECTOR FOR AN AUTOMATIC POOL CLEANER

(76) Inventor: Wayne Benjamin Balie, Port Elizabeth (ZA)

Correspondence Address: PATENT GROUP;C/O DLA PIPER US LLP, 203 N. LASALLE ST., SUITE 1900, CHICAGO, IL, 60601, US

(21) Appl. No.: 11/719,503

(22) PCT Filed: Nov. 16, 2005
(86) PCT No.: PCT/IB2005/003419

§ 371 Date: Jun. 5, 2008

(30) Foreign Application Priority Data
Nov. 17, 2004 (ZA) 2004/9205

(51) Int. Cl. F16L 55/00

(52) U.S. Cl. 285/119

(57) ABSTRACT

A connector for an automatic pool cleaner includes a body (12) with a passage therethrough and a water deflecting member (14) located in the passage. The water deflecting member is arranged so that when water passes through the passage the water impacts on the water deflecting member causing the body to rotate about a longitudinal axis of the body. The connector also includes first (16) and second (18) connecting formations for connecting the body between two pipes used to connect the automatic pool cleaner to a filter system or between one of the pipes and the automatic pool cleaner.

### BACKGROUND OF THE INVENTION

This invention relates to a connector for an automatic pool cleaner.

Automatic pool cleaners are devices which use the flow of water through them to move around the bottom of a swimming pool thereby cleaning dirt and debris off the bottom of the swimming pool.

However, these devices tend to get stuck in corners or against stairs of the swimming pool and need to be pulled out of the corners.

A number of devices exist which aim to prevent this from happening.

The present invention seeks to implement an alternative device which prevents this from happening in an improved manner.

### SUMMARY OF THE INVENTION

According to the present invention there is provided a connector for an automatic pool cleaner, the connector comprising:
a body with a passage therethrough and a water deflecting member located in the passage, the water deflecting member being arranged so that when water passes through the passage the water impacts on the water deflecting member causing the body to rotate about a longitudinal axis of the body; and
first and second connecting formations for connecting the body between two pipes used to connect the automatic pool cleaner to a filter system or between one of the pipes and the automatic pool cleaner.

The water deflecting member may be a helix.

The body is preferably made from a plastic material.

In one embodiment, the first connecting formation is implemented by sizing an end of the body to connect to the automatic pool cleaner with a friction fit.

In addition, the second connecting formation may be implemented by sizing another end of the body to connect to the pipe.

### BRIEF DESCRIPTION OF THE DRAWINGS

FIG. 1 is a perspective view of a first embodiment of a connector;

FIG. 2 is a top view of the connector of FIG. 1;

FIG. 3 is a cross sectional view of the connector of FIG. 2;

FIG. 4 is a schematic representation of the connector connected to an automatic pool cleaner;

FIG. 5 is a side view of a second embodiment of the connector;

FIG. 6 is a top view of the second embodiment of the connector; and

FIG. 7 is view of the water deflecting member along lines 7-7 of FIG. 6.

### DESCRIPTION OF EMBODIMENTS

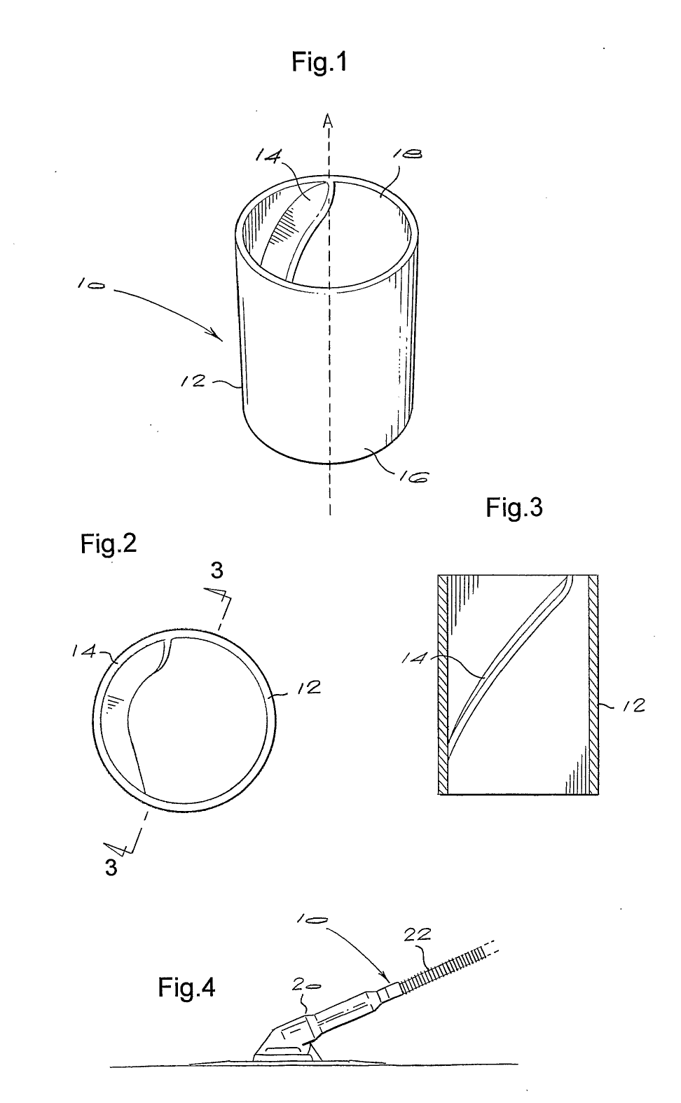

Referring to FIG. 1, a connector 10 comprises a body 12 with a passage therethrough and a water deflecting member 14 located in the passage.

The water deflecting member 14 is arranged so that when water passes through the passage the water impacts on the water deflecting member causing the body to rotate around a longitudinal axis “A” of the body.

The water deflecting member 14 of the prototype took the form of a helix as illustrated in the accompanying drawings. However, it will be appreciated that the water deflecting member may take any one of a number of other forms.

A first connecting formation 16 is used to connect the body to an automatic pool cleaner 20 (FIG. 4) so that the body is able to rotate with respect to the automatic pool cleaner 20 and a second connecting formation 18 is used to connect the body to a pipe 22 (FIG. 4) used to connect the automatic pool cleaner to a filter system (not shown).

The first connecting formation is implemented by sizing an end of the body to connect to the automatic pool cleaner 20 with a friction fit and the second connecting formation is implemented by sizing another end of the body to connect to the pipe 22.

The connecting formations ensure that when the body 12 is rotating, the first connecting formation 16 allows the body 12 to rotate freely with respect to the automatic pool cleaner 20 while the second connecting formation ensures that the rotation is transmitted to the pipe 22 thereby causing the pipe to rotate. The rotating pipe has the effect of pulling the automatic pool cleaner out of corners and away from steps where it otherwise gets stuck.

It will be appreciated that the present invention could be implemented in a number of ways. For example, for automatic pool cleaners which already have a pipe connector which rotates freely with respect to the rest of the automatic pool cleaner, the present invention could be incorporated into an otherwise standard pipe which is then just connect as the last pipe in the chain of pipes from the filter system to the automatic pool cleaner.

On the other hand, where the automatic pool cleaner does not already have a pipe connector that rotates freely with respect to the rest of the automatic pool cleaner, a bearing mechanism can be inserted in between the body and the automatic pool cleaner.

When the automatic pool cleaner is not stuck and moving normally around the pool, the present invention does not cause the pipe to become tangled up as the force exerted on the water deflecting member is not large enough to deflect the pipe under these circumstances and only comes into play when the pool cleaner is stuck.

In the prototype of the present invention, the invention was implemented with a Genius 3000™ automatic pool cleaner and whereas before the use of the present invention the automatic pool cleaner was often getting stuck against a step in a swimming pool, with the use of the present invention the pipe at that point started to twist and maneuvered the automatic pool cleaner away from the step after it had got stuck in a very effective manner.

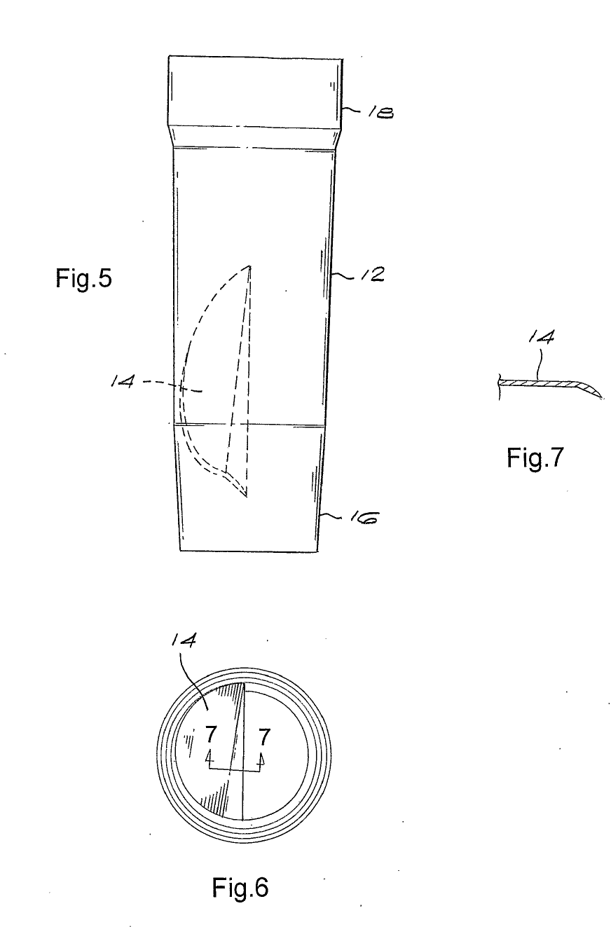

FIGS. 5, 6 and 7 show a second embodiment of the connector with like parts being referenced by like reference numerals.

In this embodiment the top of the body 12 has been enlarged slightly to form the second connecting formation 18 and the bottom has been slightly narrowed to form the first connecting formation 16.

In addition the water deflecting member 14 is shaped differently as can more clearly be seen from the cross section across the water deflecting member show in FIG. 7.

Thus it will be appreciated that the connecting formations and the water deflecting member can be modified without departing from the scope of the invention.

The second connecting formation 18 connects to a pipe 22 or to an automatic pool cleaner which is received therein in a friction fit arrangement.

The first connecting formation 16 also connects to a pipe 22 or to an automatic pool cleaner in a friction fit arrangement.

Thus it will be appreciated that this embodiment operates either between two pipes or between a pipe and an automatic pool cleaner.

In this embodiment, the rotation of the water deflecting member is transmitted to the pipes and/or pool cleaner by the friction fit. The friction fit does not easily allow the water deflecting member to rotate with respect to the pipes and/or pool cleaner and so the rotation causes the pipes to coil which changes the pattern of movement of the pool cleaner thus getting it out of corners.

It will also be appreciated that two of the devices can be connected together to further change the pattern of operation of the pool cleaning device.

1. A connector for an automatic pool cleaner, the connector including:
A body with a passage therethrough and a water deflecting member located in the passage, the water deflecting member being arranged so that when water passes through the passage the water impacts on the water deflecting member causing the body to rotate about a longitudinal axis of the body; and

2. A connector according to claim 1 wherein the water deflecting member is a helix.

3. A connector according to claim 2 wherein the body is made from a plastic material.

4. A connector according to claim 1 wherein the first and second connecting formations are implemented by sizing ends of the body to connect to the automatic pool cleaner and/or pipes with a friction fit.

5. A connector according to claim 1 wherein the body is made from a plastic material.

6. A connector according to claim 2 wherein the first and second connecting formations are implemented by sizing ends of the body to connect to the automatic pool cleaner and/or pipes with a friction fit.

7. A connector according to claim 3 wherein the first and second connecting formations are implemented by sizing ends of the body to connect to the automatic pool cleaner and/or pipes with a friction fit.
